(19) United States
(12) Patent Application Publication
(10) Pub. No.: US 2021/0207711 A1
(43) Pub. Date: Jul. 8, 2021

(54) GASKET WITH A HIGH DURABILITY COATING AND METHOD FOR CREATING THE SAME

(71) Applicant: DANA AUTOMOTIVE SYSTEMS GROUP, LLC, MAUMEE, OH (US)

(72) Inventor: MARTIN MOCKENHAUPT, BUFFALO GROVE, IL (US)

(73) Assignee: DANA AUTOMOTIVE SYSTEMS GROUP, LLC, MAUMEE, OH (US)

(21) Appl. No.: 17/272,760

(22) PCT Filed: Sep. 4, 2019
(86) PCT No.: PCT/US2019/049415

§ 371 Date: Mar. 2, 2021

Related U.S. Application Data
(60) Provisional application No. 62/728,928, filed on Sep. 10, 2018.

(51) Int. Cl. F16J 15/08

(52) U.S. Cl. CPC F16J 15/0818

(57) ABSTRACT

A gasket (14) with a high durability coating, and a method for applying the coating to the gasket is provided. The gasket may have at least a first metallic substrate layer (22) having a metallic upper surface (24) and a metallic lower surface (26). An anti-fretting coating (50) may be adhered directly to at least the metallic upper surface of the metallic substrate. A top coating (56) may be directly adhered over the entire anti-fretting coating.

### FIELD

A gasket with a high durability coating and method for creating the same is disclosed. The gasket may be, but is not limited to, a cylinder head gasket for an internal combustion engine.

### BACKGROUND

Gaskets are well-known devices for sealing interfaces between two structures. Many gaskets attempt to provide a fluid tight seal between the two structures so that fluids within the structures do not leak or otherwise escape from the structures. In one example explored herein, the structures may be such as a cylinder head and engine block, and the gasket may be a cylinder head gasket.

Known gaskets are typically provided only with a elastomeric, polymer-based coating with no anti-fretting properties. The polymer based coatings, which are rubber based coatings, may provide initial sealing between structures. These coatings, however, are not durable as they typically wear away and/or break down with temperature and pressure (which continue to rise in today's higher performance engines), exposing the hard metal of the gasket to the hard metal of the head and/or block.

The contact movement between the two surfaces to be sealed causes mechanical wear and material transfer at the surface (aka fretting), often followed by oxidation of both the metallic debris and the freshly exposed metallic surfaces. Because the oxidized debris is usually much harder than the surfaces from which it came, it often acts as an abrasive agent that increases the rate of fretting.

When the coating is worn away by fretting, corrosion and other damage, such as cracking, to the gasket typically follows. The erosion of the polymer coating, and subsequent gasket damage, typically results in failure of the gasket due to leakage of fluids or combustion.

### SUMMARY

A gasket with a high durability coating, and a method of creating the gasket, is provided. The gasket may have least a first metallic substrate layer having a metallic upper surface and a metallic lower surface. An anti-fretting coating may be adhered to the metallic upper surface of the metallic substrate. The anti-fretting coating may be selected from the group consisting of electrolytically adhered aluminum, autocatalytically adhered nickel-polytetrafluroethylene, autocatalytically adhered nickel-boron, autocatalytically adhered nickel diamond, electrolytically adhered copper, electrolytically adhered copper alloy, autocatalytically adhered nickel silicon carbide, autocatalytically adhered nickel, electrolytically adhered nickel or electrolytically adhered nickle-polytetrafluroethylene.

In another aspect, the metallic substrate layer is an embossed spring steel of 301 stainless steel.

In another aspect, the metallic substrate layer is approximately 0.015 to approximately 0.35 mm thick.

In another aspect, the metallic substrate layer is approximately 0.2 mm thick.

In another aspect, the anti-fretting coating is approximately 0.002 to approximately 0.04 mm thick.

In another aspect, the anti-fretting coating is approximately 0.007 mm thick.

In another aspect, the top coating is selected from the group consisting of wax, rubber and/or polytetrafluorethylene.

In another aspect, the top coating is approximately 0.0001 mm to approximately 0.15 mm thick.

In another aspect, the top coating is approximately 0.010 mm thick.

In another aspect, the anti-fretting coating is directly adhered to the lower metallic surface.

In another aspect, the top coating is directly adhered over the entire anti-fretting coating on the lower metallic surface.

In another aspect, a second and third metallic substrate layer are provided wherein two of the first through third metallic substrate layers have a least one surface with the anti-fretting coating applied directly to each surface wherein one metallic substrate layer does not have the anti-fretting coating.

In another aspect, the second metallic substrate layer is located between the first and third metallic substrate layers, wherein the first and third metallic substrate layers each have at least one surface with the anti-fretting coating applied directly to each surface wherein the second metallic substrate layer does not have any surface with the anti-fretting coating.

In another aspect, the first metallic substrate layer has a half bead at an opening in the first metallic substrate layer and a full bead, wherein a land separates the half bead and the full bead, wherein upper and lower surfaces of the first metallic substrate layer have the anti-fretting coating.

In another aspect, the second metallic substrate layer is a constant thickness semi-stopper layer that extends beneath the full bead and at least partially to the land area but terminates before the half bead.

In another aspect, the second metallic substrate layer is a shim layer that extends beneath the full bead and the half bead, the shim having at least a portion with an increased thickness area.

In another aspect, upper and lower surfaces of the first and third layers are both entirely coated with the anti-fretting coating.

In another aspect, the anti-fretting coating on the upper and lower surfaces of the first and third layers are coated with the top coating.

In another aspect, a fourth layer is provided where the fourth layer has an upper and a lower surface entirely coated with the anti-fretting coating and the top coating, the fourth layer having a full bead and a half bead, both in alignment with the first layer full bead and half bead, respectively, the fourth layer located beneath the third layer.

In another aspect, a fifth layer is provided, the fifth layer having an upper and a lower surface entirely coated with the anti-fretting coating and the top coating, the fifth layer having a full bead and a half bead, both in alignment with the first layer full bead and half bead, respectively, the fifth layer located beneath the fourth layer.

In another aspect, a second, a third and a fourth metallic substrate layer are provided, wherein two of the first through fourth layers have a least one surface with the anti-fretting coating applied directly to the surface, wherein the top coating is adhered over the entire anti-fretting coating, wherein two middle metallic substrate layers do not have the anti-fretting coating, wherein one of the middle metallic substrate layers is a constant thickness distance layer and another of the middle layers had a folded over stopper.

In another aspect, a second, a third and a fourth metallic substrate layer are provided, wherein each of the metallic substrate layers has at least one surface with the anti-fretting coating applied directly to the surface, wherein each of the metallic substrate layers has a full bead and each of the metallic substrate layers has a half bead at an opening, wherein each of the beads are aligned respectively with one another, each of the beads separated by a land area, wherein the top coating is located over said anti-fretting coatings.

In another aspect, the top coating is worn away to leave only said anti-fretting coating.

In another aspect, the top coating is worn away by an engine component in direct contact with, and initially fluid tight sealed by, the coating.

In another aspect, upon removal of at least part of the top coating, the anti-fretting coating conforms to a surface of a directly adjacent engine block or cylinder head cover to create a seal.

### BRIEF DESCRIPTION OF THE DRAWINGS

The above, as well as other advantages, will become readily apparent to those skilled in the art from the following detailed description when considered in the light of the accompanying drawings in which:

FIG. 1 is a schematic perspective exploded view of one embodiment of an engine block, a gasket and a cylinder head;

FIG. 2 is a plan view of the gasket from FIG. 1;

FIG. 3 is a schematic partial cut away side view along line 3-3 of FIG. 2;

FIG. 4 is a schematic partial cut away side view of an alternative embodiment along line 3-3;

FIG. 5 is a schematic partial cut away side view of an alternative embodiment along line 3-3;

FIG. 6 is a schematic partial cut away side view of an alternative embodiment along line 3-3;

FIG. 7 is a schematic partial cut away side view of an alternative embodiment along line 3-3;

FIG. 8 is a schematic partial cut away side view of an alternative embodiment along line 3-3; and

FIG. 9 is a schematic partial cut away side view of an alternative embodiment along line 3-3.

### DETAILED DESCRIPTION OF THE PREFERRED EMBODIMENTS

It is to be understood that the gasket and method may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise.

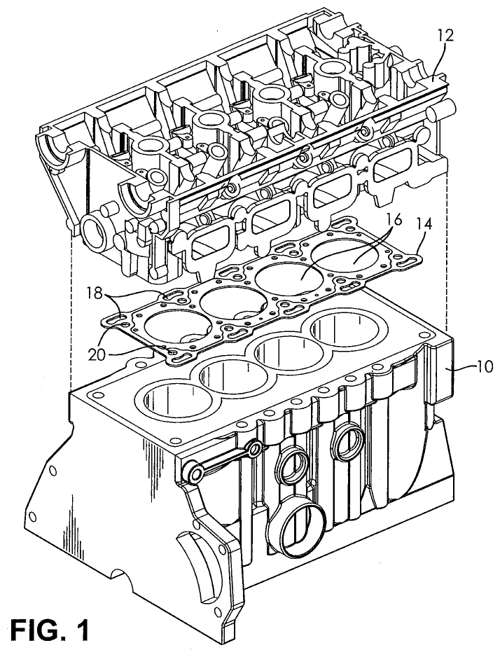

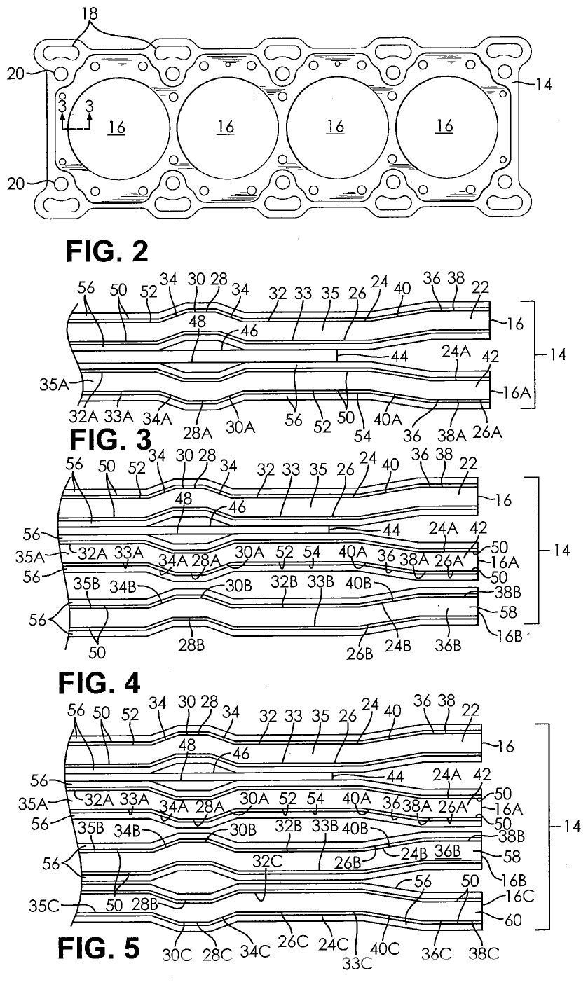

Turning now to FIG. 1, one embodiment of a cylinder block 10, a cylinder head 12 and a cylinder head gasket 14 is schematically depicted. The gasket 14 is comprised of a plurality of holes, as shown in FIG. 2. The holes may comprise combustion openings 16, fluid openings 18 and mechanical fastener openings 18. The gasket 14 provides a sealing function between the block 10 and the head 12, as well as for the combustion, fluid and fastener 16, 18, 20 openings in the gasket 14. While one embodiment of the gasket 14, block 10 and head 12 are depicted, the shape and size of each may vary from the depiction in FIGS. 1 and 2.

Turning to FIG. 3, one embodiment of a partial cross sectional side view through line 2-2 from FIG. 2 is schematically depicted. In this embodiment, the gasket 14 has a first metallic substrate layer 22 with a metallic upper surface and a metallic lower surface 24, 26. The first metallic substrate layer 22 may be an uppermost layer of the gasket. The first metallic substrate layer 22 may have a full bead 28 integrally formed with the layer 22. The full bead 28 may be comprised of an elevated portion 30 that is elevated from a planar upper surface 32 by two angled portions 34 on either side of the elevated portion 30. Radially opposite the planar upper surface 32 is a planar lower surface 33. The planar upper surface 32 and the planar lower surface 33 comprise a planar portion 35.

A combustion opening 16 in the first metallic substrate layer 22 may be surrounded by a half bead 36. The half bead 36 may be comprised of an elevated portion 38 that is elevated from the planar upper surface 32 by an angled portion 40. The half bead 36 and the full bead 28 may be separated from one another by the planar upper surface 32. The elevated portions 30, 38 of the full bead 28 and the half bead 36 may be coplanar with one another, but not coplanar with the planar upper surface 32; the elevated portions 30, 38 may be parallel the planar upper surface 32. The planar upper surface 32 may continue radially inward after the full bead 22.

The upper and lower surfaces 24, 26 may define between them a constant thickness, despite the variations from the beads 28, 36. The upper and lower surfaces 24, 36 are preferably parallel one another across the first metallic substrate layer 22.

The embodiment depicted in FIG. 3 has a second metallic substrate layer 42 that maybe a mirror image of the first metallic substrate layer 22. Reference numbers used for the same features described above for the first metallic substrate layer 22 are used for the second metallic substrate layer 42 with an “A” designation. The second metallic substrate layer 42 comprises metallic upper and lower surfaces 24A, 26A, a planar portion 35A, a full bead 28A and a half bead 36A, among other features.

A stopper layer 44 may be located between the first metallic substrate layer 22 and the second metallic substrate layer 42. The stopper layer 44 may also be deemed a metallic substrate layer. The stopper may be defined by a planar upper surface 46 and a planar lower surface 48. The two surfaces 46, 48 may define between them a constant thickness.

The stopper layer 44 may extend entirely or partially between the first and second metallic substrate layers 22, 42. In the depicted embodiment, the stopper layer 44 may continuously extend beneath the full bead 28 radially outwardly under the planar portion 35 toward the half bead 36. FIG. 3 shows the stopper layer 44, terminating under a portion of the planar portion 35 before reaching the angled portion 40 of the half bead 36.

The metallic substrate layers 22, 42 and/or the stopper layer 44 may be constructed of 301 stainless steel. The metallic substrate layers 22, 42 may each be approximately 0.100 to approximately 0.4 mm thick. The stopper layer 44 is preferably thinner than the metallic substrate layers 22, 42. The stopper layer 44 may be approximately 0.075 mm to 0.2 mm.

Those skilled in the art appreciate that the head 12 and block 10 may move slightly with respect to one another during operation of the engine. The gasket 14, being located between the head 12 and block 10, may receive some or all of that motion. Unless the gasket 14 is protected, fretting damage to the gasket 14 may result when the block 10 and head 12 move with respect to the gasket 14. Fretting causes wear, or degradation, of the gasket surfaces that often result in corrosion, cracking, failure and/or leaking of the gasket 14.

In one embodiment, an anti-fretting coating 50 may be applied to at least one of the surfaces of at least one of the metallic substrate layers. Preferably, the coating 50 is applied at least to the surface, or surfaces, of the metallic substrate layer that most directly receives the fretting. In the embodiment depicted in FIG. 3, the coating 50 may be applied over the entire metallic upper surfaces 24, 24A and the entire metallic lower surfaces 26, 26A of the first metallic substrate layer 22 and the second metallic substrate layer 42. Preferably, the coating 50 is applied directly to the surfaces 24, 24A, 26, 26A. In other words, there are no intervening structures or layers between the coating 50 and the surfaces 24, 24A, 26, 26A. In the depicted embodiment, the coating 50 may not be applied to the stopper layer 44.

The anti-fretting coating 50 must be durable enough to pass the rigors of engine testing with a significant reduction (e.g., 70 to 100%) in surface damage to the metallic substrate 22, 42. Surface damage can comprise extrusion of any coatings on the substrate 22, 42, and lead to oxidation. This oxidation damage increases stresses in gaskets and often leads to cracking of the base gasket. The crack allows fluids or combustion to leak through the gasket. The coating 50 is preferably a minimum 3 to 10 times more durable in bench tests simulating engines operating in high compression and temperature conditions compared to substrates without the coating.

By way of example of the durability of the anti-fretting coating 50, testing shows that FKM type rubber coatings are destroyed in the first one million cycles of engine testing. A cycle may comprise a sinusoidal repetition on a fixture. These tests may be commonly known as a fatigue friction test with a sinusoidal force cycle in a load test frame.

When the FKM type rubber coating is removed, the substrate is directly exposed to fretting damage. The substrate surface oxidizes without the rubber coating in a fretting environment. Continued testing of this gasket typically results in the substrate developing cracks around three million cycles. An anti-fretting coating 50, such as nickel PFTE described below, permits the substrate 22, 42 to endure ten million cycles without any damage.

The anti-fretting coating 50, applied to the metallic substrate layer surfaces 24, 24A, 26, 26A, will have a contacting surface 52 where it is in direct contact with the surfaces 24, 24A, 26, 26A. Opposite the contacting surface 52, the coating 50 will have an outermost surface 54. The contacting surface 52 and the outermost surface 54 define between them a thickness. In one embodiment, the thickness may be 0.003 mm to approximately 0.04 mm thick. In one preferred embodiment, the thickness may be approximately 0.007 mm thick. The coating 50 may have a constant thickness across each surface 24, 24A, 26, 26A.

The anti-fretting coating 50 may be selected from the group consisting of electrolytically adhered aluminum, autocatalytically adhered nickel polytetrafluroethylene (PTFE), autocatalytically adhered nickel-boron, autocatalytically adhered nickel diamond, electrolytically adhered copper, electrolytically adhered copper alloy, autocatalytically adhered nickel silicon carbide, or autocatalyically or electrolytically adhered nickel. The electrolytic application may be such as electric deposition plating, also known as electroplating.

As may be appreciated from the above, the anti-fretting coating 50 is preferably a metal based coating. For example, it has been found that certain metals, such those mentioned above, are robust enough to withstand fretting between the head 12 and the block 10 (or between any two moving parts) but are soft enough to provide a fluid tight seal between the parts. In order to provide these performance characteristics it is preferable that the anti-fretting coating 50 does not have any polymer material.

Preferably, the anti-fretting coating 50 does not measurably degrade or disappear during the life of the substrate 22, 42. It has been found that typically, all or substantially all of the initial anti-fretting coating 50 on the gasket 14 remains after many millions (even tens of millions) of testing cycles. Thus, it has been advantageously found that high degrees of motion, pressure and temperatures are tolerated extremely well by the coating 50.

One reason the anti-fretting coating 50 does not appreciably degrade is that it may provide a hard surface that can resist the fretting. While the coating 50 may be hard, it is not so hard that it cannot conform to features of the block 10 or head 12. This characteristic provides the coating 50 with an ability to seal the block 10 and head 12.

Where aluminum, or aluminum alloy, comprises the anti-fretting coating 50, aluminum oxide results when the coating 50 is applied. It is believed the aluminum oxide at least contributes to the hard surface. In one embodiment, the hard surface may be rated 9 on the Moh's scale. The coating 50 provides a dense and void-free surface that acts as an impervious barrier providing the coating 50 with excellent corrosion and wear properties.

The aluminum oxide may comprise the uppermost layer or surface of the coating 50 on the substrate. In other words, the aluminum oxide may comprise the outermost surface 54, or surface that is in direct contact with the engine part (e.g., head or block). The aluminum oxide layer protects the softer aluminum layer beneath the oxide layer.

The aluminum or aluminum alloy anti-fretting coating may be electrically deposited in an oxygen free environment. When plating is complete, first exposure to air creates an initial tough and durable aluminum oxide surface. As this initial oxide layer is stressed and worn away, another hard oxide layer forms to protect the aluminum beneath it. Thus, this type of anti-fretting coating 50 has the advantage of being self-healing to protect the underlying layer.

An aluminum anti-fretting coating may be comprised of high purity aluminum (e.g., 99.99%+ aluminum). This has advantage of being free of contaminants, impurities, inclusions or other elements that can act as corrosion initiation sites.

The coating 50 may also be comprised of copper and copper alloys. Copper may tarnish, thus an additional coating, such as described below, may be needed to prevent or reduce the tarnishing. Copper and copper alloys do not have the hardness of the aluminum oxide layer. Copper and its alloys, however, have a natural lubricity which is beneficial when dealing with fretting between two structures.

In the case of a nickel polytetrafluroethylene (PTFE) coating, a layer mostly of PTFE forms the outermost surface 54, which provides very low friction to the coating surface 50, and the nickel functions as a carrier or conduit of anti-fretting materials such as PTFE, boron and diamonds. PTFE is known to have the third lowest coefficient of friction in the world.

The nickel polytetrafluroethylene exists as a matrix which may comprise approximately 70% nickel and 30% polytetrafluroethylene. The matrix is sponge-like with pockets of PTFE. The matrix is complimentary to the role of the coating 50 in that the nickel provides strength to PTFE which is known to lack strength on its own.

During use of the coating, PTFE material embedded in the coating 50 may be released. The release of the PTFE provides lubricity to the coating 50, which further accommodates the relative motion of the engine parts and prevents further wear to the coating 50. It has been found that nickel PTFE also readily conforms to the surface of the metallic layer surface. The conformity may be by virtue of the PTFE and its release from the coating 50. Namely, the PTFE may release from the surface of the coating 50 resulting in a conformation of the coating 50 with the adjacent part, which results in a seal between the coating 50 and the part.

The coating 50 may also be comprised of nickel boron. Nickel boron is harder than nickel PFTE, but it also has the advantage of high lubricity via the boron. Here also, the nickel boron is a matrix of mostly nickel with pockets of boron. A nickel diamond coating may also be used. The nickel diamond coating also exists as a matrix comprised mostly of nickel with pockets of diamond.

The coating 50, however, being applied as noted above permits it to flow into and adhere to the surface 24, 24A, 26, 26B of the metallic layers 22, 42. This permits it to conform and adhere to the metallic layer surface 24, 24A, 26, 26B despite any typical surface roughness of the metallic layer surface 24, 24A, 26, 26B.

Nickel boron has a low coefficient of friction/high lubricity. This, coupled with the high hardness of nickel boron, makes nickel boron highly resistant to fretting. Cracking, and other wear, on the substrate 22, 42 is prevented by virtue of these properties reducing the internal stresses on the substrate 22, 42.

Nickel diamond is similar to nickel boron, but it has a higher coefficient of friction. The addition of diamonds though makes the surface extremely wear resistant. This prevents the formation of surface wear out. Surface wear out increases the surface friction when shear motion is applied by the engine operation. The shear motion leads to the formation of high internal stresses, which may crack the substrate 22, 42.

Silicon nickel carbide is similar to nickel boron in that it has a low coefficient of friction/high lubricity. This, coupled with the high hardness of nickel boron, makes nickel boron highly resistant to fretting. Silicon carbide is a hard material that can be dissolved in nickel. The nickel solution can then be electroplated onto a substrate. The mechanical action of the parts rub off the exposed nickel, leaving a very hard layer of silicon carbide to protect the parts from direction contact with one another.

Electroless anti-fretting coatings 50, such as nickel PFFE, nickel boron or nickel diamond do not require an electric current through the coating solution for them to deposit on the substrate. Thus, these coatings 50 can be less expensive to apply than coatings 50 requiring electricity. Electroless coatings 50 nevertheless have the advantage of preventing corrosion and wear of the substrate 22, 42. Electroless application of coatings 50 has the further advantage of permitting powder or powders to be suspended in the solutions. By way of one example, PTFE powder can be suspended in the nickel solution for application to the substrate 22, 42 for use in the anti-fretting coating 50.

The coating 50, such as an electroless or electrolytic coating, may be applied by plating. Plating produces a relatively tough, solid surface that forms between the coating 50 and the metallic substrate 22, 42 that is free of polymers or binders. The plating results in the coating 50 forming an atomic bond with the substrate 22, 42. Those skilled in the art appreciate that atomic bonding is the strongest form of bonding between two structures. The tough, solid surface is also a product of the relatively high density and compact structure of the coating 50. These characteristics provide the coating 50 with high temperature and wear resistance to mechanical fretting.

Preferably, the coating 50 is applied entirely across at least one surface 24, 24A, 26, 26A of the substrate 22, 42. This results in a continuous, uninterrupted, homogenous, unitary, coating 50 across the surface 24, 24A, 26, 26A of the substrate 22, 42 effectively encapsulating that surface 24, 24A, 26, 26A of the substrate 22, 42 within the coating 50. The coating 50 may also be applied on more than one surface 24, 24A, 26, 26A of the substrate 24, 42 such as to encapsulate the entire substrate 22, 42 within the coating 50.

Testing has shown that the coating 50 can decrease fretting motion or action on the gasket 14. The decrease in fretting has increased the durability of the gasket 14 by at least three fold compared to gaskets without the coating.

A top coating 56 may be directly adhered over the entire anti-fretting coating 50. In one embodiment, the top coating 56 is located directly on the outermost surface 54 of the anti-fretting coating 50. In other words, there are no intervening structures or layers between the coatings 50, 56.

The top coating 56 may be selected from the group consisting of wax (e.g., paraffin wax), rubber, silicone and/or polytetrafluorethylene (PTFE). The top coating 56 may be applied in a thickness of approximately 0.0003 mm to approximately 0.50 mm thick. In a preferred embodiment, the coating 56 may be approximately 0.015 mm thick. The top coating 56 may have a constant thickness on the anti-fretting coating 50.

The top coating 56 may be a sacrificial, or temporary, coating 56 that wears away in whole or in part over time from the anti-fretting layer 50. The survival of the top coating 56 may be tailored to the specific situation. There may be situations where the top coating 56 should survive for a relatively short period of time or at least for initial engine air leaking testing (see below). The period of time or testing may comprise approximately 1 hour of engine operation or the first few cycles (as defined above).

The coating 56 type and thickness of its application are factors in how long and/or under what conditions the coating 56 may last. By way of one example, wax may be used for surfaces (e.g. surfaces such as 24, 24A, 26, 26A and/or surfaces of the block and/or head) with waviness less than 10 microns. A polymer, like silicone, may be used for surfaces (as noted above) with thickness typically 10 microns.

Another factor for top coating 56 thickness determination may be the surface roughness of the block 10 and head 12: the more significant the surface (as noted above) roughness, the thicker the coating 56 may need to be to accommodate the roughness and assist with sealing with these surfaces (as noted above).

The top coating 56 may function to provide a seal between the head 12 and block 10, such as for initial testing of the engine. During the initial testing, the engine may reach performance parameters of temperature and pressure that are higher than standard operating conditions. The anti-fretting coating 56 provides an additional sealing function to the gasket 14 so the gasket 14 performs well under these conditions.

The top coating 56 may wear off after the initial testing, or during regular operation of the engine. The top coating 56 is preferably softer than the anti-fretting coating 50 applied beneath it. By way of example on relative softness, the top coating 56 may have a Moh's rating of approximately 1.

Preferably, the selected top coating 56 is less expensive than traditional coatings, such as FKM. FKM may be generally defined as ASTM D1418 as a fluoroelastomers. Typically, FKMs contain vinylidene fluoride as a monomer.

The top coating 56 can be applied by roll coating, dip coating, or spraying, all of which are relatively easy, quick and inexpensive application methods.

As the coating wears, the anti-fretting coating 50 may be exposed in whole or in part. Typically, at some point substantially all of the top coating 56 is worn off leaving just the anti-fretting coating 50. Upon removal of at least part of the top coating 56, the anti-fretting coating 50 conforms to a surface of a directly adjacent engine block 10 or cylinder head 12 to create a seal therebetween. The process of conforming may be assisted by the elevated temperature and/pressure in the engine environment.

It is also permissible to entirely forego the top coating 56. These situations may be such as when the parts to be sealed (e.g., the engine block 10 and the cylinder head 12) have finished surfaces without significant imperfections and may be sealed by the anti-fretting coating 50 and the metallic substrate layers 24, 24A, 26, 26A alone.

FIG. 4 depicts another embodiment where a third metallic substrate layer 58 is added to the first and second metallic substrate layers 22, 42 and the stopper layer 44 depicted in FIG. 3. In the depicted embodiment, the third metallic substrate layer 58 is located directly beneath the second metallic substrate layer 42.

The third metallic substrate layer 58 may be the same in shape and structure as the first metallic substrate layer 22. Reference numbers used for the same features described above are used for the third metallic substrate layer 58 with a “B” designation. The third metallic substrate layer 58 may have metallic upper and lower surfaces 24B, 26B, a full bead 28B and a half bead 36B separated by a planar portion 35B. The full bead 28B and the half bead 36B are vertically aligned with the full and half beads 28, 28A, 36, 36A of the first and second layers 22, 42. In the installed condition, at least the elevated portions 30A, 38A of the full and half beads 28A, 36A, 28B, 36B of the second and third metallic substrate layers 22, 42 are in contact with one another.

The third metallic substrate layer 58 may have the anti-fretting coating 50 and top coating 56 applied to one or more of its surfaces 24B, 26B as noted above. Preferably, the coatings 50, 56 are provided entirely across the upper and lower surfaces 24B, 26B.

FIG. 5 depicts another embodiment where a fourth metallic substrate layer 60 is added to the first, second and third metallic substrate layers 22, 42, 58 described above. Reference numbers used for the features described above for the second metallic substrate layer 42 are used for the fourth metallic substrate layer 60 with a “C” designation.

The fourth metallic substrate layer 60 may be located directly beneath the third metallic substrate layer 58. The fourth metallic substrate layer 60 may be the same in shape and structure as the second metallic substrate layer 42. For example, the fourth metallic substrate layer 58 may have metallic upper and lower surfaces 24C, 26C, a full bead 28C and a half bead 36C separated by a planar portion 35C. The full bead 28C and the half bead 36C of the fourth metallic substrate layer 60 are aligned with the full and half beads 28, 28A, 28B, 36, 36A, 36B of the first, second and third metallic layers 22, 42, 58.

In the installed condition, at least the elevated portions of the full and half beads 28A, 28B, 36A, 36B of the second and third metallic substrate layers 42, 58 are in contact with one another as there is no intervening stopper or other layer between them. The planar portions 35A, 35B of the third and fourth layers 58, 60 are in contact with one another in the installed condition as there is no intervening stopper or other layer between them. Thus, the planar lower surface 33B, such as comprising the planar portion 35B of the third metallic substrate layer 58 is in direct contact with a planar upper surface 32C, such as comprising the planar portion 35C of the fourth metallic substrate layer 60.

The fourth metallic substrate layer 60 may have the anti-fretting coating 50 and top coating 56 applied to one or more of its surfaces 24C, 26C as noted above. Preferably, the coatings 50, 56 are provided entirely across the upper and lower surfaces 24C, 26C.

A variation of FIGS. 3-5 comprises only adding the anti-fretting coating 50 to the stopper layer 44. The anti-fretting coating 50 may be applied to the upper and/or lower surfaces 46, 46A-C, 48, 48A-C of the stopper layer 44, 44A-C. The anti-fretting coating 50 may not be provided on the beaded, or active, metallic substrate layers 22, 42, 58, 60. The beaded, or active, metallic substrate layers 22, 42, 58, 60 may be provided with the top coating 56.

Another variation on the above is to add the anti-fretting coating 50 to every other layer 22, 42, 58, 60, or just the outside layers 22, 60 (even just the outside surfaces of the outside layers). Selective layer application of the anti-fretting coating 50 or the top coating 56 may save time and money.

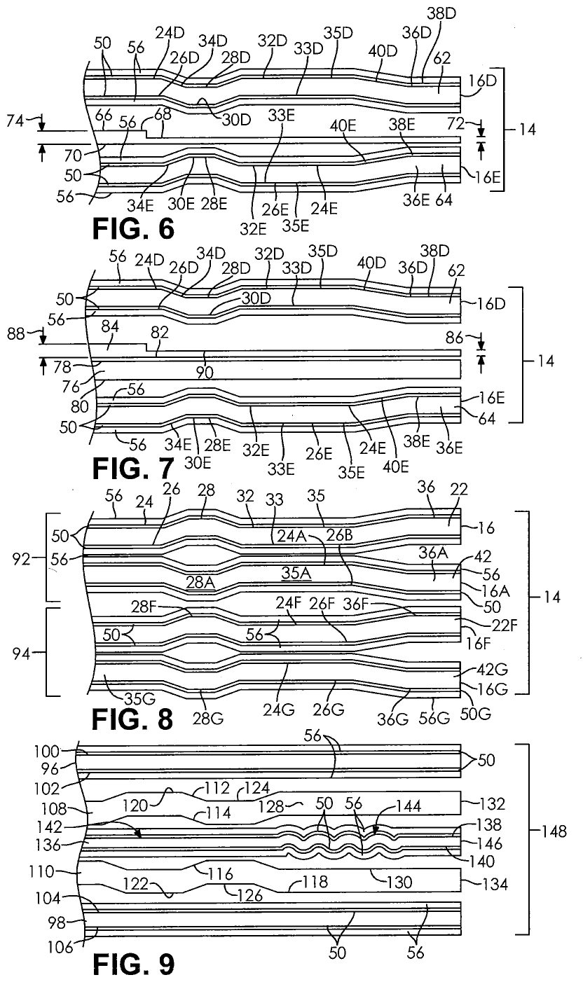

FIG. 6 depicts another embodiment comprised of an uppermost metallic substrate layer 62 comprised of the second metallic substrate layer 42 described above in FIG. 2. The embodiment also includes a lowermost metallic substrate layer 64 comprised of the first metallic substrate layer 22 described above in FIG. 2. The uppermost and lowermost metallic substrate layers 62, 64 have the same features as the second and first metallic substrate layers 42, 22, respectively. The same reference numbers from the second and first metallic substrate layers 42, 22 are used with the uppermost and lowermost layers 62, 64 with the addition of a “D” designation and “E” designation, respectively.

The full and half beads of the layers 28D, 36D, 28E, 36E, 62, 64 are vertically aligned with one another. As shown in the figure, the full bead 28D and the half bead 36D of the uppermost layer 62 may extend, such as downwardly, toward the full bead 28E and the half bead 36E respectively of the lowermost layer 64, which may extend, such as upwardly, toward the full bead 28D and the half bead 36D respectively of the uppermost layer 62.

The embodiment may also include a shim layer 66 between the uppermost and lowermost metallic substrate layers 62, 64. The shim layer 66 may also be deemed a metallic substrate layer. In the depicted embodiment, the shim layer 66 may extend continuously and uninterrupted from the aligned combustion openings 16D, 16E of the uppermost and lowermost layers 62, 64, past the half beads 36D, 36E, past the planar portions 35D, 35E and past the full beads 28D, 28E. In the installed condition, the elevated portions 30D, 30E of the full beads 28D, 28E and the half beads 36D, 36E of both layers 62, 64 may be in contact with upper and lower layers 68, 70 of the shim 66.

The shim 66 depicted in FIG. 6 may be comprised of two thicknesses. As shown in FIG. 6, a first thickness 72, which may be approximately half of a second thickness 74, may be located radially inward from the full beads 28D, 28E. The second thickness 74, which may be located radially inward from the full beads 28D, 28E, may be from two shims being connected together, such as through welding (e.g., laser welding) or the like.

The shim 66 may or may not have the anti-fretting 50 and/or top coatings 56. In the embodiment depicted in FIG. 6, the shim 66 does not have either the anti-fretting 50 or top coating 56.

Turning now to FIG. 7 another embodiment is depicted where the uppermost and lowermost metallic substrate layers 62, 64 from FIG. 6 are provided with intervening layers. One of the intervening layers may be such as a spacer layer 76. The spacer layer 76 may be deemed a metallic substrate layer. The spacer layer 76 may have an upper surface 78 and a lower surface 80. A constant thickness may be defined between the surfaces 78, 80. The spacer layer 76 may be unitary and extend uninterrupted from the combustion opening 16D, 16E radially inwardly beyond the full beads 28D, 28E of the uppermost and lowermost layers 62, 64. In one embodiment, the spacer layer 76 may be located directly above the lowermost layer 64. In this location, the elevated portion 30D, 30E, 38D, 38E of the full and half beads 28D, 28E, 36D, 36E may be located in direct contact with the lower surface 80 of the spacer layer 76 in an installed condition. The upper surface 78 of the spacer layer 76 may be in contact with a lower surface 82 of a shim layer 84.

The shim layer 84 may be comprised of two thicknesses. A first thickness 86, which may be approximately half of a second thickness 88, may be located radially inward from the full beads 28D, 28E continuously radially outward to the combustion opening 16D, 16E.

In one embodiment, the second thickness 88 may be created by folding over the shim layer 84 onto itself. In another embodiment, the second thickness 88 may be created by welding a separate part comprised of the second thickness 88 to the shim layer 84. The welding may be such as laser welding.

The second thickness 88 may be located radially inward from the full beads 28D, 28E. The shim layer 84 has an upper surface 90 and a lower surface 82.

In the embodiment depicted in FIG. 7, the shim and spacer layers 84, 76 are not provided with the anti-fretting 50 or top coating 56. The uppermost and lowermost spacer layers 62, 64 are provided with the anti-fretting 50 and top coatings 56 as described above.

Turning now to FIG. 8, first and second sets 92, 94 of first and second metallic substrates from FIGS. 2 and 3 are provided. In this embodiment, reference numbers for the upper set 92 of first and second metallic substrates 22, 42 are the same as those provided in FIG. 2. Reference numbers for the lower set 94 of the first and second metallic substrates are the same as with the upper set 92 but provided with an “F” and “G” designation, respectively.

The two sets 92, 94 of first and second metallic substrates 22, 42, 22F, 42, 42G are stacked on one another such that the full beads 28, 28A, 28F, 28G, half beads 36, 36A, 36F, 36G and planar portions 35, 35A, 35F, 35G are vertically aligned with one another. A shim, stopper or other structure is not located between the upper and lower substrate sets 92, 94, or between the individual substrate layers 22, 42, 22F, 42G.

The anti-fretting coating 50 may be applied to each layer 22, 42, 22F, 42G as described above. In addition, the top coating 56 may be applied to each layer 22, 42, 22F, 42G as described above.

FIG. 9 depicts a five layer embodiment where each of the layers is a metallic substrate. Upper and lower outermost metallic substrates 96, 98 may each have planar upper 100, 104 and lower 102, 106 surfaces that define substantially constant thicknesses between them.

Upper and lower intermediate metallic substrates 108, 110 also both have upper 112, 116 and lower 114, 118 surfaces that define a substantially constant thickness between them. The upper and lower intermediate metallic substrates 108, 110 may have full beads 120, 122 located between two planar portions 124, 126. The full beads 120, 122 may be vertically aligned with one another.

The upper and lower intermediate metallic substrates 108, 110 may also have half beads 128, 130. The half bead 128 on the upper intermediate metallic substrate 108 may be a downwardly extending bead 128 located axially beyond the planar portion 124 distal a combustion opening 132. The half bead 130 on the lower intermediate metallic substrate 110 may be an upwardly extending bead 130 located axially beyond the planar portion 126 distal a combustion opening 134. The two half beads 128, 130 are vertically aligned with one another.

The lower surface 102 of the upper outermost metallic substrate 96 may be in direct contact with the upper surface 112 of the upper intermediate metallic substrate 108. The upper surface 104 of the lower outermost metallic substrate 98 may be in direct contact with the lower surface 118 of the lower intermediate metallic substrate 110.

A single middle metallic substrate 136 may be located between the intermediate metallic substrates 108, 110. The middle metallic substrate 136 may have an upper surface 138 in direct contact with the lower surface 114 of the upper intermediate metallic substrate 108. The middle metallic substrate 136 may also have a lower surface 140 in direct contact with the upper surface 116 of the lower intermediate metallic substrate 110. The middle metallic substrate 136 may have at least one planar portion 142 and a wave portion 144. The wave portion 144 may be located closer to a combustion opening 146. The wave portion 144 may be axially bounded by planar portions 142. The wave portion 144 may be such as a stopper portion to prevent over compression of the gasket 148.

In one embodiment, the upper 100, 104 and lower 102, 106 surfaces of the upper and lower outermost metallic substrates 96, 98 are provided with the anti-fretting coating 50. The upper and lower surfaces 138, 140 of the middle metallic substrate 136 may also be provided with the anti-fretting coating 50. The upper surface 100 of the upper outermost metallic substrate 96 may be provided with the top coating 56. Similarly, the lower surface 106 of the lower outermost metallic substrate 98 may be provided with the top coating 50. No other layers are provided with the anti-fretting coating 50 or the top coating 56.

In accordance with the provisions of the patent statutes, the device and method of creating the device has been described in what is considered to represent its preferred embodiments. However, it should be noted that the device and method can be practiced otherwise than as specifically illustrated and described without departing from its spirit or scope.

What is claimed is:

1. A gasket with a high durability coating, comprising:
at least a first metallic substrate layer having a metallic upper surface and a metallic lower surface;
an anti-fretting coating adhered directly to the entire metallic upper surface of the metallic substrate;
wherein said anti-fretting coating is selected from the group consisting of electrolytically adhered aluminum, electrolytically adhered aluminum alloy, autocatalytically adhered nickel-polytetrafluroethylene, autocatalytically adhered nickel-silicon carbide, autocatalytically adhered nickel-boron, autocatalytically adhered nickel diamond, electrolytically adhered copper, electrolytically adhered copper alloy, autocatalyically or electrolytically adhered nickel or electrolytically adhered nickel-polytetrafluroethylene; and
a top coating directly adhered over the entire anti-fretting coating.

2. The gasket of claim 1, wherein said metallic substrate layer is an embossed spring steel of 301 stainless steel.

3. The gasket of claim 1, wherein said metallic substrate layer is approximately 0.015 to approximately 0.35 mm thick.

4. The gasket of claim 3, wherein said metallic substrate layer is approximately 0.2 mm thick.

5. The gasket of claim 1, wherein anti-fretting coating is approximately 0.002 to approximately 0.04 mm thick.

6. The gasket of claim 5, wherein said anti-fretting coating is approximately 0.007 mm thick.

7. The gasket of claim 1, wherein said top coating is selected from the group consisting of wax, rubber, silicone and polytetrafluorethylene.

8. The gasket of claim 1, wherein said top coating is approximately 0.0001 mm to approximately 0.15 mm thick.

9. The gasket of claim 8, wherein said top coating is approximately 0.010 mm thick.

10. The gasket of claim 1, wherein said anti-fretting coating is directly adhered to the lower metallic surface.

11. The gasket of claim 10, wherein said top coating is directly adhered over the entire anti-fretting coating on the lower metallic surface.

12. The gasket of claim 1, further comprising a second metallic substrate layer and third metallic substrate layer, wherein two of said first through third metallic substrate layers have a least one surface with said anti-fretting coating applied directly to each surface wherein one metallic substrate layer does not have said anti-fretting coating.

13. The gasket of claim 12, wherein said second metallic substrate layer is located between said first and third metallic substrate layers, wherein said first and third metallic substrate layers each have at least one surface with said anti-fretting coating applied directly to each surface wherein said second metallic substrate layer does not have any surface with said anti-fretting coating.

14. The gasket of claim 13, wherein said first metallic substrate layer has a half bead at an opening in said first metallic substrate layer and a full bead, wherein a land separates said half bead and said full bead, wherein upper and lower surfaces of said first metallic substrate layer have said anti-fretting coating.

15. The gasket of claim 14, wherein said second metallic substrate layer is a constant thickness semi-stopper layer that extends beneath said full bead and at least partially to said land area but terminates before said half bead.

16. The gasket of claim 14, wherein said second metallic substrate layer is a shim layer that extends beneath said full bead and said half bead, said shim having at least a portion with an increased thickness area.

17. The gasket of claim 17, wherein upper and lower surfaces of said first and third layers are both entirely coated with said anti-fretting coating.

18. The gasket of claim 17, wherein said anti-fretting coating on said upper and lower surfaces of said first and third layers are coated with said top coating.

19. The gasket of claim 12, further comprising a fourth layer, said fourth layer having an upper and a lower surface entirely coated with said anti-fretting coating and said top coating, said fourth layer having a full bead and a half bead, both in alignment with said first layer full bead and half bead, respectively, said fourth layer located beneath said third layer.

20. The gasket of claim 19, further comprising a fifth layer, said fifth layer having an upper and a lower surface entirely coated with said anti-fretting coating and said top coating, said fifth layer having a full bead and a half bead, both in alignment with said first layer full bead and half bead, respectively, said fifth layer located beneath said fourth layer.

21. The gasket of claim 1, further comprising a second, a third and a fourth metallic substrate layer, wherein two of said first through fourth layers have a least one surface with said anti-fretting coating applied directly to the surface, wherein said top coating adhered over the entire anti-fretting coating, wherein two middle metallic substrate layers do not have said anti-fretting coating, wherein one of said middle metallic substrate layers is a constant thickness spacer layer and another of said middle layers had a folded over stopper.

22. The gasket of claim 1, further comprising a second, a third and a fourth metallic substrate layer, wherein each of said metallic substrate layers has at least one surface with said anti-fretting coating applied directly to the surface, wherein each of said metallic substrate layers has a full bead and each of said metallic substrate layers has a half bead at an opening, wherein each of said beads are aligned respectively with one another, each of said beads separated by a land area, wherein said top coating is located over said anti-fretting coatings.

23. A method of creating a gasket with a high durability coating, comprising:
providing a metallic substrate layer having a metallic upper surface and a metallic lower surface;
locating an anti-fretting coating directly to the entire metallic upper surface of the metallic substrate layer;
wherein said anti-fretting coating is selected from the group consisting of electrolytically adhered aluminum, electrolytically adhered aluminum alloy, autocatalytically adhered nickel-polytetrafluroethylene, autocatalytically adhered nickel-silicone carbide, autocatalytically adhered nickel-boron, autocatalytically adhered nickel diamond, electrolytically adhered copper, electrolytically adhered copper alloy, autocatalyically or electrolytically adhered nickel or electrolytically adhered nickel-polytetrafluroethylene; and
providing a top coating directly adhered over the entire anti-fretting coating.

24. the method of claim 23, further comprising wearing away said top coating to leave only said anti-fretting coating.

25. The method of claim 25, wherein said top coating is worn away by an engine component in direct contact with, and initially fluid tight sealed by, said top coating.

26. The method of claim 26, wherein upon removal of at least part of the top coating, the anti-fretting coating conforms to a surface of a directly adjacent engine block or cylinder head cover to create a seal.
